(19) United States
(12) Patent Application Publication
(10) Pub. No.: US 2010/0282898 A1
(43) Pub. Date: Nov. 11, 2010

(54) AIRCRAFT STRUCTURE WITH MODIFIED CONTROL DEVICE HINGE LINE

(75) Inventor: Robert James Heath, Bristol (GB)

Correspondence Address: LOWE HAUPTMAN HAM & BERNER, LLP, 1700 DIAGONAL ROAD, SUITE 300, ALEXANDRIA, VA, 22314, US

(73) Assignee: AIRBUS UK LIMITED, Bristol (GB)

(21) Appl. No.: 12/811,231

(22) PCT Filed: Jan. 22, 2009
(86) PCT No.: PCT/GB2009/050055

§ 371 Date: Jun. 30, 2010

(30) Foreign Application Priority Data
Jan. 31, 2008 (GB) 0801762.6

(51) Int. Cl. B64C 9/02

(52) U.S. Cl. 244/99.2

(57) ABSTRACT

An aircraft structure including a main structure element, a control device, a hinge assembly and an actuator. The hinge assembly includes a spar bracket attached to a rear spar in the main structure element, and a control device bracket attached to control device spar. The hinge assembly is pivotally coupled to the spar bracket about a hinge line, about which the actuator rotates the control device. The actuator is pivotally coupled to the main element at a first pivot point and to the control device at a second pivot point, the length of the actuator between the pivot points being adjustable for rotation of the control device. The hinge line is positioned closer to the rear spar than to the control device spar. A flexible line is fixed to the main structure element, and extends in a span-wise direction along the structure.

### FIELD OF THE INVENTION

The present invention relates to an aircraft structure such as a wing, horizontal tail plane or vertical tail plane, incorporating a hinge assembly pivotally coupling a control device such as an aileron, elevator or rudder to a trailing edge of the structure.

### BACKGROUND OF THE INVENTION

The trailing edge of a conventional aircraft wing is shown in FIG. 1. The wing comprises a main wing element with a rear spar 1, upper cover 2 and lower cover 3. An aileron 4 is coupled to the rear spar 1 by a hinge assembly comprising a spar bracket 5 attached to the rear spar, and an aileron bracket 6 attached to the aileron spar and pivotally coupled to the spar bracket about a hinge line 7. A hydraulic actuator 8 expands and contracts to rotate the aileron about the hinge line 7.

The arrangement of FIG. 1 limits the chord length available for the aileron. To obtain a control surface of sufficient size the aileron must be extended inboard and thus limits the span-wise extent of the flaps. Where high lift performance is the dominant design-driver the wing area may need to be increased, degrading the overall performance of the aircraft.

In addition, the spar bracket 5 is complex and bulky to install in the trailing edge (which is the smallest part of the wing) resulting in cost and weight penalties.

Furthermore, it is necessary to route cable and pipe runs through a closed gap 9 in the spar bracket 5. This can be difficult and time consuming.

### SUMMARY OF THE INVENTION

A first aspect of the invention provides an aircraft structure comprising: a main element comprising a rear spar; a control device comprising a control device spar; and a hinge assembly comprising: a spar bracket attached to the rear spar, and a control device bracket attached to the control device spar and pivotally coupled to the spar bracket about a hinge line; and an actuator pivotally coupled to the main element at a first pivot point and to the control device at a second pivot point, the length of the actuator between the pivot points being adjustable so as to rotate the control device in a first direction about the hinge line from a neutral position to a first deployed position, and in a second opposite direction about the hinge line from the neutral position to a second deployed position; wherein the hinge line is positioned closer to the rear spar than to the control device spar.

By positioning the hinge line closer to the rear spar than to the control device spar, the chord length of the control device can be increased giving design freedom to take advantage of a more powerful control surface, decrease the angle of movement of the control device, decrease the span of the control device or a combination of these factors.

The control device may comprise an aileron, elevator, rudder, or any control device which has a neutral position and can be rotated either side of the neutral position. Typically the control device occupies the full depth of the aerodynamic cross-section of the structure, in contrast with control devices such as spoilers or air brakes which only occupy part of the depth.

The structure may comprise for example the main wing of the aircraft, the horizontal tail plane (also known as the horizontal stabilizer), or the vertical tail plane (also known as the vertical stabilizer).

The structure may further comprises a flexible line (such as a hydraulic pipe or electrical cable) which is fixed to the main element and extends in a span-wise direction along the structure. In this case, preferably the flexible line passes through a gap which is located outside the hinge assembly.

Preferably the control device further comprises upper and lower control device covers which are attached to the control device spar and overhang forward of the control device spar. In this case the control device bracket may comprise a continuous web which is attached to the control device spar and both covers. However such a continuous structure can be relatively heavy so more preferably the control device bracket comprises an upper bracket arm attached to the upper control device cover and a lower bracket arm attached to the lower control device cover.

Various other preferred features of the invention are described in the dependent claims.

### BRIEF DESCRIPTION OF THE DRAWINGS

Embodiments of the invention will now be described with reference to the accompanying drawings, in which:

FIG. 1 is a schematic sectional view of a trailing edge of a conventional aircraft wing;

FIG. 2 is a schematic sectional view of a trailing edge of an aircraft wing according to an embodiment of the present invention with the aileron in its neutral position; and

FIG. 3 is an isometric schematic view of the aileron shown in section in FIG. 2.

### DETAILED DESCRIPTION OF EMBODIMENT(S)

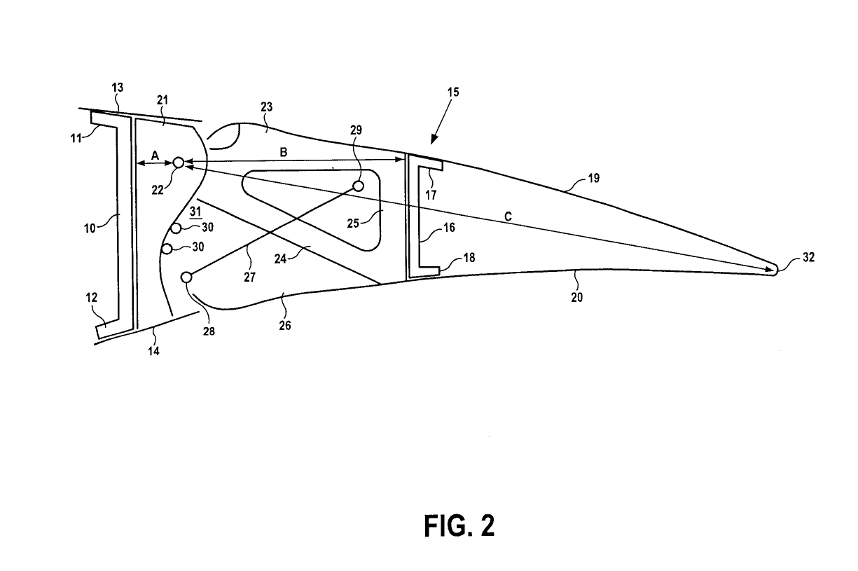

The trailing edge of an aircraft wing according to an embodiment of the present invention is shown in FIG. 2.

The wing comprises a main wing element with a C-section rear spar, and upper and lower covers 13,14 which are attached to the rear spar and overhang to its rear. The rear spar comprises a web 10 extending between the upper and lower covers 13,14, and upper and lower flanges 11,12.

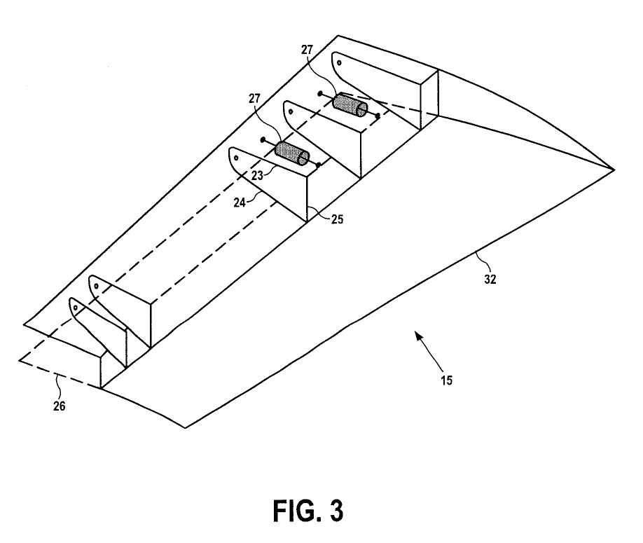

An aileron 15 shown in FIG. 3 is pivotally attached to the rear spar. The aileron 15 comprises a C-section front spar 16-18, and upper and lower aileron covers 19,20 which are attached to the front spar and overhang to its front. The front spar comprises a web 16 extending between the upper and lower covers 19,20, and upper and lower flanges 17,18.

The aileron 15 is pivotally coupled to the rear spar by a hinge assembly comprising a spar bracket 21 and an aileron bracket 23-25. The spar bracket 21 is attached to the covers 13,14 and to the web 10 of the rear spar by fasteners (not shown). The aileron bracket 23-25 is attached to the aileron covers 19,20 and to the web 16 of the aileron spar by fasteners (not shown). The brackets are pivotally coupled together about a hinge line defined by a pivot pin 22.

The aileron bracket comprises an upper bracket arm 23 attached to the upper aileron cover 19 along the majority of its length, a lower bracket arm 24 attached to the lower aileron cover 20 at its foot only, and a strut 25 which is attached to the aileron spar web 16 by fasteners (not shown) and extends between the upper and lower bracket arms. The aileron bracket has a so-called “A-frame” structure with the arms 23,24 extending at an acute angle to each other and meeting at the hinge line. Note that the strut 25 may be omitted if necessary, and the distal ends of the arms 23 attached to the spar web 16 as well as a respective cover 19,20.

A panel 26 is attached to a leading edge of the lower aileron cover 20 by a butt strap or similar fastening arrangement (not shown). The panel 26 can be removed to provide access to the actuator 27 and the various other elements between the aileron and the rear spar.

A hydraulic linear actuator 27 is pivotally coupled to the main wing element by a first actuator hinge assembly (not shown) at a first pivot point 28 and to the aileron 15 by a second actuator hinge assembly (not shown) at a second pivot point 29. The length of the actuator 27 between the pivot points 28, 29 can be expanded or contracted so as to rotate the aileron about the hinge line 22 between a pair of upper and lower deployed positions on opposite sides of a neutral position shown in FIG. 2. In the neutral position the aileron covers 19,20 are in line with the covers 13,14 of the main wing element. As shown in FIG. 3, the aileron has five aileron hinge brackets, and two actuators 27 are provided to deploy the aileron.

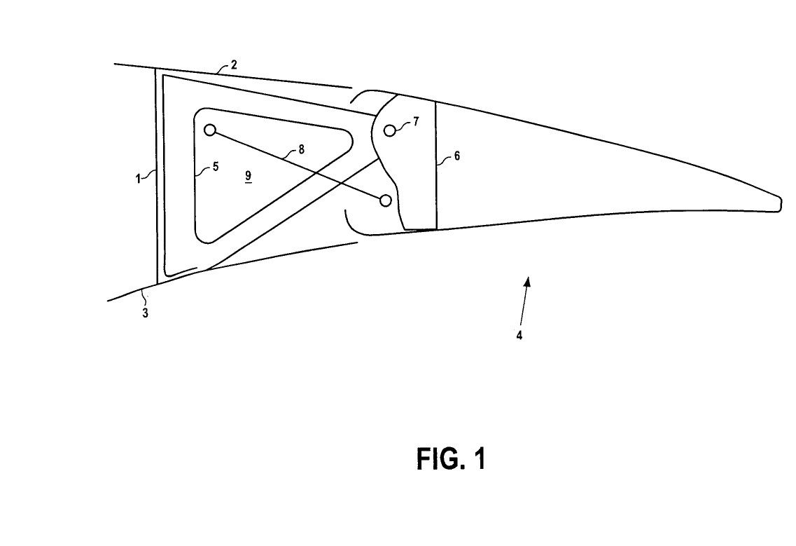

Flexible electrical cables and hydraulic pipes 30 are fixed to the rear spar and extend in a span-wise direction along the wing through a gap 31 between the spar bracket 21 and the aileron bracket 23-25. Assembly of the wing is simplified because the lines 30 can be attached directly to the main wing element before the aileron is installed. Furthermore, because the lines 30 pass through a gap 31 which is located outside the hinge assembly there is no need to feed them through a closed gap within the hinge assembly, as in the conventional arrangement of FIG. 1.

Furthermore, in contrast with the conventional arrangement shown in FIG. 1, in at least the neutral position shown in FIG. 2, the hinge line 22 is positioned:
closer to the web 10 of the rear spar than to the web 16 of the aileron spar. That is, the shortest distance between the hinge line 22 and the web 10 of the rear spar (as indicated by distance A in FIG. 2) is less than the shortest distance between the hinge line 22 and the web 16 of the aileron spar (as indicated by distance B in FIG. 2)
forward of a point half way between the actuator pivot points 28,29
closer to the first actuator pivot point 28 than to the second actuator pivot point 29.

By positioning the hinge line 22 further forward than in the conventional arrangement shown in FIG. 1, the chord length of the aileron can be increased giving design freedom to take advantage of a more powerful surface for roll control or high lift, decrease the angle of movement as the aileron is deployed, decrease the span of the aileron or a combination of these factors.

The space available for the actuator is substantially unchanged from the conventional arrangement shown in FIG. 1. However, the space occupied by the actuator is now part of the movable surface instead of the fixed structure. That is, at least a majority of the length of the actuator 27 is positioned within the chord length of the aileron.

Note that that in contrast to the conventional arrangement shown in FIG. 1, the distance B between the hinge line and the aileron spar web 16 is greater than 25% of the distance C between the hinge line and a trailing edge 32 of the aileron. In this example distance B is approximately 38% of distance C. Note also that in contrast to the flaperon described in US 2007/0114328, a line between the hinge line 22 and the trailing edge 32 of the aileron passes through the aileron spar web 16.

Furthermore, in contrast to the conventional arrangement shown in FIG. 1, the first actuator pivot point 28 is positioned lower than the second actuator pivot point 29, at least in the neutral position shown in FIG. 2, in order to maximise the moment arm of the actuator.

Although the invention has been described above with reference to one or more preferred embodiments, it will be appreciated that various changes or modifications may be made without departing from the scope of the invention as defined in the appended claims.

1. An aircraft structure comprising:
a main element comprising a rear spar,
a control device comprising a control device spar, and
a hinge assembly comprising:
a spar bracket attached to the rear spar, and
a control device bracket attached to the control device spar and pivotally coupled to the spar bracket about a hinge line; and
an actuator pivotally coupled to the main element at a first pivot point and to the control device at a second pivot point, the length of the actuator between the pivot points being adjustable so as to rotate the control device in a first direction about the hinge line from a neutral position to a first deployed position, and in a second opposite direction about the hinge line from the neutral position to a second deployed position;
wherein the hinge line is positioned closer to the rear spar than to the control device spar.

2. The structure of claim 1 further comprising a flexible line which is fixed to the main element, and extends in a span-wise direction along the structure.

3. The structure of claim 2 wherein the flexible line passes through a gap which is located outside the hinge assembly.

4. The structure of claim 1 wherein the hinge line is positioned forward of a point half way between the pivot points, in at least one position of the control device.

5. The structure of claim 1 wherein the hinge line is positioned closer to the first pivot point than to the second pivot point, in at least one position of the control device.

6. The structure of claim 1 wherein the control device further comprises upper and lower control device covers which are attached to the control device spar and overhang forward of the control device spar.

7. The structure of claim 6 wherein the control device bracket comprises an upper bracket arm attached to the upper control device cover and a lower bracket arm attached to the lower control device cover.

8. The structure of claim 7 wherein the control device bracket further comprises a strut which abuts the control device spar and extends between the upper and lower bracket arms.

9. The structure of claim 1 wherein the main element further comprises upper and lower covers; the rear spar comprises a rear spar web extending between the upper and lower covers; the control device further comprises upper and lower control device covers; the control device spar comprises a control device spar web extending between the upper and lower control device covers; and the hinge line is positioned closer to the rear spar web than to the control device spar web.

10. The structure of claim 1 wherein the distance between the hinge line and the control device spar is greater than 25% of the distance between the hinge line and a trailing edge of the control device.

11. The structure of claim 1 wherein a line between the hinge line and a trailing edge of the control device passes through the control device spar.

12. The structure of claim 1 wherein the control device comprises an aileron.

13. The structure of claim 1 wherein at least a majority of the length of the actuator between the pivot points is positioned within the chord length of the control device.

14. The structure of claim 1 wherein the control device occupies the full depth of the aerodynamic cross-section of the structure.
